(19) United States
(12) Patent Application Publication
(10) Pub. No.: US 2008/0001384 A1
(43) Pub. Date: Jan. 3, 2008

(54) TRIM SYSTEM FOR A VEHICLE

(75) Inventors: Roger Catron, Washington, MI (US); Eric Stefan Mozer, Rochester, MI (US); John Frederick, Romeo, MI (US)

Correspondence Address: BROOKS KUSHMAN P.C.;INTL. AUTOMOTIVE COMPONENTS GROUP, 1000 TOWN CENTER, TWENTY-SECOND FLOOR, SOUTHFIELD, MI, 48075, US

(73) Assignee: LEAR CORPORATION, Southfield, MI (US)

(21) Appl. No.: 11/427,556

(22) Filed: Jun. 29, 2006

(51) Int. Cl. B60R 21/21; B60R 21/215

(52) U.S. Cl. 280/730.2; 280/728.3

(57) ABSTRACT

A trim system for a vehicle including a mounting member is provided. An airbag may be disposed between a handle and the mounting member if the handle is attached to the mounting member.

### BACKGROUND OF THE INVENTION

### 1. Field of the Invention

The invention generally relates to a trim system for a vehicle.

### SUMMARY

In an aspect of the invention, a trim system for a vehicle including a mounting member and an inflatable airbag is provided. The system includes a trim piece. The trim piece includes a handle member that is attachable to the mounting member. The trim piece also includes a covering member configured to cover a portion of the mounting member. The covering member is attachable to the mounting member such that at least a portion of the covering member is moveable relative to the handle member if the covering member experiences a force during inflation of the airbag. The airbag is capable of being disposed between a surface of the mounting member and a surface of the handle member if the handle member is attached to the mounting member.

In an aspect of the invention, a trim system for a vehicle including a mounting member and an inflatable airbag is provided. The system includes a trim piece. The trim piece includes a handle member that is attachable to the mounting member. The trim piece also includes a covering member configured to cover a portion of the mounting member. The trim piece is capable of being retained by a retaining portion of the handle member such that at least a portion of the covering member is moveable relative to the handle member if the covering member experiences a force during inflation of the airbag. The airbag is capable of being disposed between a surface of the mounting member and a surface of the handle member if the handle member is attached to the mounting member.

In an aspect of the invention, a trim system for a vehicle including a mounting member is provided. The system includes a handle member configured to be mechanically fixed to the mounting member. The system also includes a covering member configured to cover a portion of the mounting member. The covering member is attachable to the mounting member. The system further includes an inflatable airbag capable of being disposed between a surface of the handle member and a surface of the covering member. At least a portion of the covering member is moveable relative to the handle member if the covering member experiences a force during inflation of the airbag.

While exemplary embodiments in accordance with the invention are illustrated and disclosed, such disclosure should not be construed to limit the claims. It is anticipated that various modifications and alternative designs may be made without departing from the scope of the invention.

### BRIEF DESCRIPTION OF THE DRAWINGS

FIG. 1 shows an embodiment of the invention;

FIG. 2 shows a section of the embodiment of FIG. 1;

FIG. 3 shows a section of the embodiment of FIG. 1;

FIG. 4 shows a section of the embodiment of FIG. 1; and

FIG. 5 shows a section of the embodiment of FIG. 1.

### DETAILED DESCRIPTION

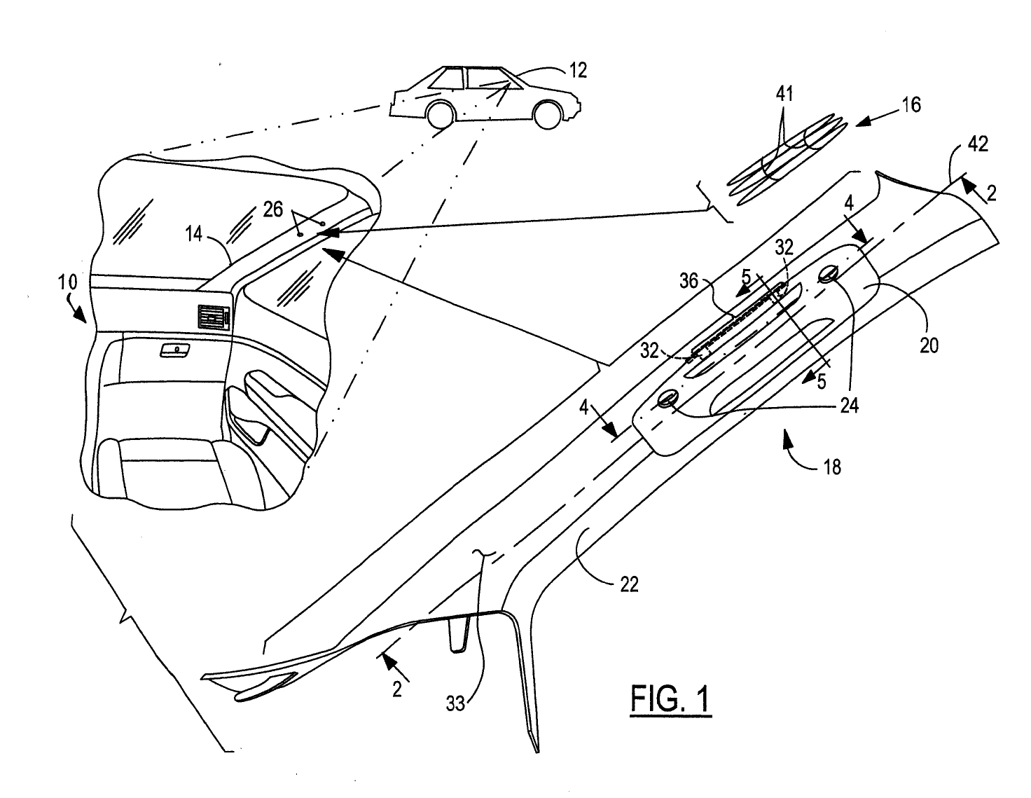

FIG. 1 shows a trim system 10 for a vehicle 12 that includes a mounting member, e.g., an A-pillar 14, an inflatable air bag 16, and a trim piece 18. The trim piece 18 includes a handle member, or handle 20, and a covering member, or cover 22.

The handle 20 is attachable to the A-pillar 14. The handle 20 may be mechanically fixed to the A-pillar 14. The handle 20 may be screwed to the A-pillar 14. The handle 20 may be bolted to the A-pillar 14. The handle 20 may be attached to the A-pillar 14 in any desired fashion. The handle 20 provides openings 24 through which fasteners may pass and engage the handle 20. Likewise, the A-pillar 14 provides openings 26 though which fasteners, if any, associated with the handle 20 may pass.

The cover 22 is configured to cover a portion of the A-pillar 14. In the embodiment of FIG. 1, the cover 22 covers the A-pillar 14.

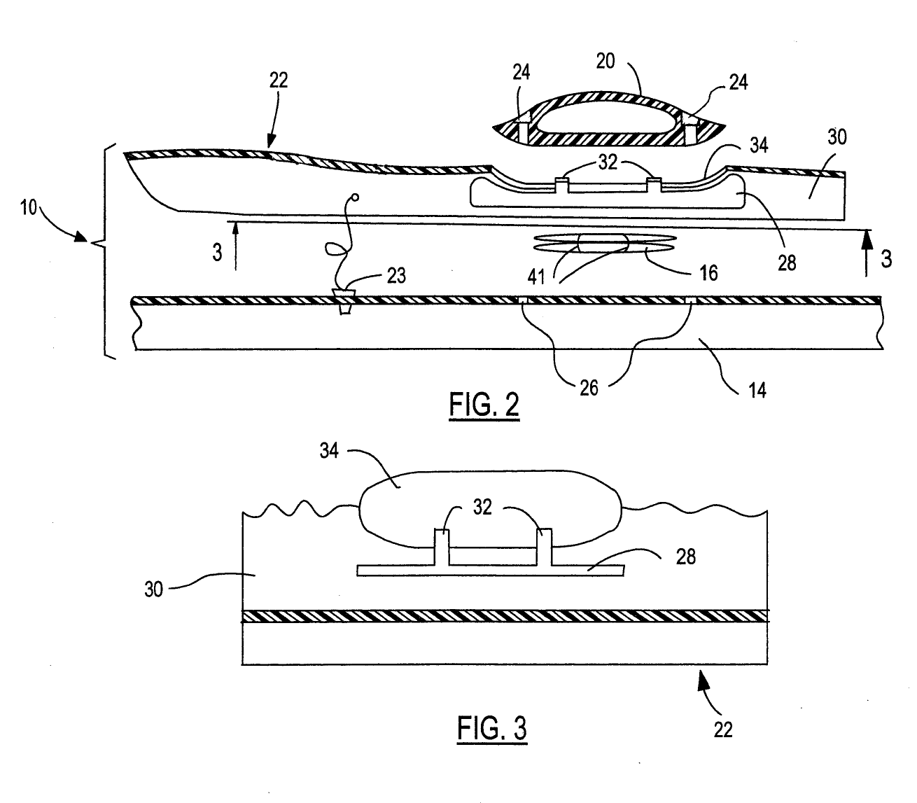

FIG. 2 shows a section of the trim system 10 taken along section line 2-2 of FIG. 1. The cover 22 includes two (2) portions: a first portion 28 and a second portion 30. The first portion 28 is attached to the second portion 30. The first portion 28 may be bolted to the second portion 30. The first portion 28 may be welded to the second portion 30. The first portion 28 may be attached to the second portion 30 in any desired fashion.

In an alternative embodiment, the cover 22 is single piece.

In an alternative embodiment, the first portion 28 is reusable and the second portion 30 is disposable. After inflation of the airbag 16, the disposable portion 30 may be replaced and the cover 22 can be reinstalled in the vehicle 12.

FIG. 3 shows a section of the cover 22 taken along section line 3-3 of FIG. 2. The first portion 28 includes finger portions, or fingers 32, that extend into an opening 34 of the cover 22. The fingers 32 are configured to deform if the airbag 16 is inflated. The opening 34 accommodates the handle 20 and airbag 16 as will be explained below in detail. The fingers 32 are configured to be disposed between a retaining portion, e.g., a lip 36, (FIG. 1) of the handle 20 and the A-pillar 14 if the handle 20 is attached to the A-pillar 14. The cover 22 is held in place by the lip 36, if the handle 20 is attached to the A-pillar 14, via the fingers 32. The cover 22 is moveable relative to the handle 20 if the airbag 16 is inflated as will be explained below in detail. The movement of the cover 22 relative to the handle 20 may cause the fingers 32 to deform. The cover 22 may also be tethered to the A-pillar 14 by tether clip 23.

In an alternative embodiment, the cover 22 may be attached, e.g., tethered by tether clip 23, to the A-pillar 14 such that at least a portion of the cover 22 is moveable relative to the handle 20 during inflation of the airbag 16. The cover 22 may be attached to the A-pillar 14 in any desired fashion. In this embodiment, the fingers 32 may not be configured to deform and may not serve to hold the cover 22 in place if the handle 20 is attached to the A-pillar 14.

The first portion 28 may be made of the same material as the second portion 30, e.g., polypropylene. The first portion 28 may have a thickness that is greater than the second portion 30. As such, properties of the fingers 32 may be different from properties of an exterior surface 33 (FIG. 1) of the cover 22. For example, the fingers 32, and first portion 28, may provide support for the handle 20 for head impact energy management.

In an alternative embodiment, the first portion 28 may be made from a material, e.g., glass filled nylon, different from the second portion 30, e.g., polypropylene. The first portion 28 has material properties different from material properties of the second portion 30. The material properties of the fingers 32 are different from the material properties of the exterior surface 33 of the cover 22.

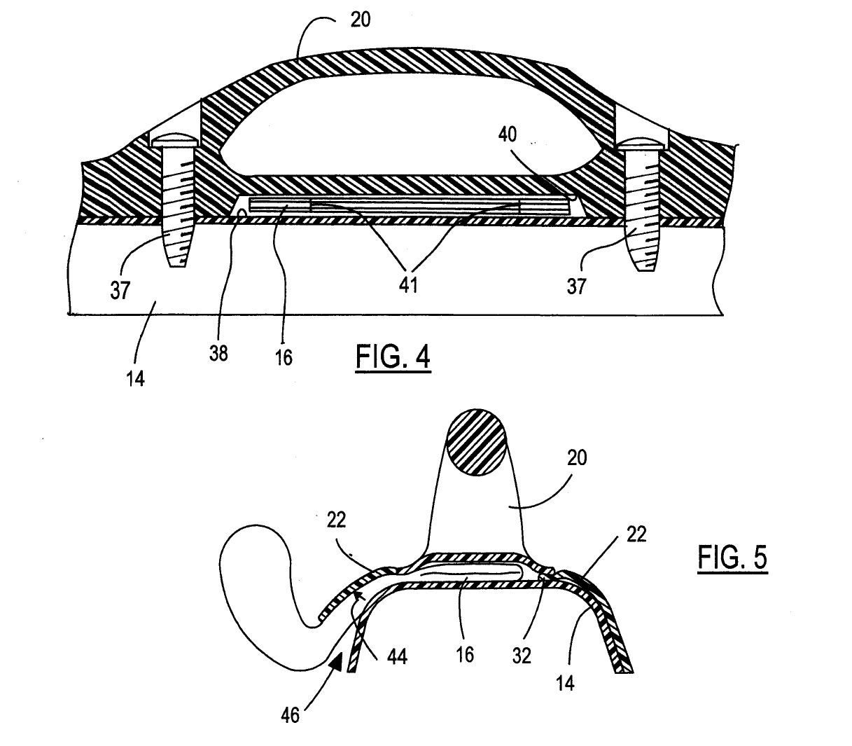

FIG. 4 shows a section of the trim system 10 taken along section line 4-4 of FIG. 1. The handle 20 is attached to the A-pillar 14 with screws 37. The airbag 16 is disposed in a folded position between a surface 38 of the A-pillar 14 and a surface 40 of the handle 20. The airbag 16 is held in its folded position by, for example, tether clips 41. The surface 38 and the surface 40 are generally parallel. The airbag 16 is located generally to the right of axis 42 (FIG. 1).

FIG. 5 shows a section of the trim system 10 taken along section line 5-5 of FIG. 1. During inflation of the airbag 16, the airbag 16 exerts a force 44 against the cover 22. The force 44 moves the cover 22 relative to the handle 20 in a direction generally normal to the A-pillar 14. The airbag 16 escapes through a space 46 between the A-pillar 14 and the cover 22.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A trim system for a vehicle including a mounting member and
an inflatable airbag comprising:
a trim piece including
a handle member attachable to the mounting member, and
a covering member configured to cover a portion of the mounting member and being attachable to the mounting member such that at least a portion of the covering member is moveable relative to the handle member if the covering member experiences a force during inflation of the airbag; and
wherein the airbag is capable of being disposed between a surface of the mounting member and a surface of the handle member if the handle member is attached to the mounting member.

2. The system of claim 1 wherein the covering member further includes a finger portion that is capable of being disposed between the handle member and the mounting member if the handle member is attached to the mounting member thereby providing support for the handle member.

3. The system of claim 2 wherein the covering member includes an exterior surface and wherein the finger portion has properties that are different from properties of the exterior surface.

4. The system of claim 1 wherein the handle member is capable of being mechanically fixed to the mounting member.

5. The system of claim 1 wherein the handle member is capable of being screwed to the mounting member.

6. The system of claim 1 wherein the handle member is capable of being bolted to the mounting member.

7. The system of claim 1 wherein the covering member includes a disposable portion and a reusable portion, the reusable portion being removably attached to the disposable portion and including a finger portion that is capable of being disposed between the handle member and the mounting member if the handle member is attached to the mounting member.

8. The system of claim 1 wherein the covering member is capable of being tethered to the mounting member.

9. A trim system for a vehicle including a mounting member and
an inflatable airbag comprising:
a trim piece including
a handle member including a retaining portion and being attachable to the mounting member, and
a covering member configured to cover a portion of the mounting member and capable of being retained by the retaining portion of the handle member such that at least a portion of the covering member is moveable relative to the handle member if the covering member experiences a force during inflation of the airbag; and
wherein the airbag is capable of being disposed between a surface of the mounting member and a surface of the handle member if the handle member is attached to the mounting member.

10. The system of claim 9 wherein the covering member includes a finger portion that is capable of being disposed between the retaining portion of the handle member and the mounting member if the handle member is attached to the mounting member thereby holding the covering member in place.

11. The system of claim 10 wherein the finger portion is capable of deforming if the covering member experiences the force during inflation of the airbag.

12. The system of claim 10 wherein the covering member includes an exterior surface and wherein the finger portion has properties that are different from properties of the exterior surface.

13. The system of claim 9 wherein the handle member is capable of being mechanically fixed to the mounting member.

14. The system of claim 9 wherein the handle member is capable of being screwed to the mounting member.

15. The system of claim 9 wherein the handle member is capable of being bolted to the mounting member.

16. The system of claim 9 wherein the covering member includes a disposable portion and a reusable portion, the reusable portion being removably attached to the disposable portion and including a finger portion that is capable of being disposed between the handle member and the mounting member if the handle member is attached to the mounting member.

17. The system of claim 16 wherein properties of the reusable portion are different from properties of the disposable portion.

18. A trim system for a vehicle including a mounting member comprising:
a handle member configured to be mechanically fixed to the mounting member;
a covering member configured to cover a portion of the mounting member and being attachable to the mounting member;
an inflatable airbag capable of being disposed between a surface of the handle member and a surface of the covering member; and
wherein at least a portion of the covering member is moveable relative to the handle member if the covering member experiences a force during inflation of the airbag.

19. The system of claim 18 wherein the covering member includes a first portion and a second portion and wherein the first and second portions are welded together.

20. The system of claim 18 wherein the covering member includes a first portion and a second portion and wherein the first and second portions are bolted together.
